(19) United States
(12) Patent Application Publication
(10) Pub. No.: US 2014/0295262 A1
(43) Pub. Date: Oct. 2, 2014

(54) ELECTROLYTE SOLUTION FOR LITHIUM METAL BATTERY, AND LITHIUM METAL BATTERY

(71) Applicants: Hirofumi NAKAMOTO, Susono-shi (JP); Yoshiumi KAWAMURA, Susono-shi (JP)

(72) Inventors: Hirofumi NAKAMOTO, Susono-shi (JP); Yoshiumi KAWAMURA, Susono-shi (JP)

(73) Assignee: TOYOTA JIDOSHA KABUSHIKI KAISHA, Toyota-shi (JP)

(21) Appl. No.: 14/221,830

(22) Filed: Mar. 21, 2014

(30) Foreign Application Priority Data
Mar. 29, 2013 (JP) 2013-072227

(51) Int. Cl. H01M 10/0566

(52) U.S. Cl. CPC H01M 10/0566
USPC 429/200; 429/188; 564/292; 548/574

(57) ABSTRACT

An electrolyte solution for a lithium metal battery includes an ionic liquid that has a cation that includes a nitrogen atom and an ether group. The nitrogen atom at a center of the cation and an oxygen atom on the ether group are arranged with a single carbon atom being located between the nitrogen atom and the oxygen atom.

### INCORPORATION BY REFERENCE

The disclosure of Japanese Patent Application No. 2013-072227 filed on Mar. 29, 2013 including the specification, drawings and abstract is incorporated herein by reference in its entirety.

### BACKGROUND OF THE INVENTION

1. Field of the Invention

The invention relates to an electrolyte solution for use in lithium metal batteries.

2. Description of Related Art

Developments in cutting edge electronics industries have recently enabled electronics equipment to be made smaller and lighter, resulting in a broad expansion in the use of mobile electronic devices. Today, with the growing need for batteries having a high energy density to power such mobile electronic devices, research is actively being carried out on lithium secondary batteries.

Of these, lithium metal batteries, in which lithium metal is utilized as the negative electrode, are noteworthy because of their ability to achieve a high capacity. Because lithium has a low density of 0.54 g/cm³ and also has a very low standard reduction potential of −3.054 V (using a standard hydrogen electrode (SHE) as the reference electrode), it has attracted attention as an electrode material for high-energy density batteries.

Organic solvents were formerly used in electrolytes for lithium metal batteries. However, in an organic electrolyte solution, lithium at the negative electrode precipitates in a dendritic form, which tends to give rise to internal shorting. Moreover, due to the presence of chemically active lithium metal together with a flammable organic solvent, ensuring a level of safety that can withstand practical use was difficult.

With the growing desire for safety, progress is being made on the development of flame-retarding electrolyte solutions. In such investigations, ionic liquids have shown promise as flame-retarding electrolyte solutions. Such ionic liquids include N-methyl-N-propylpiperidinium bis(trifluoromethanesulfonyl)amide (PP13TFSA) (Japanese Patent Application Publication No. 2011-14478 (JP 2011-14478 A)) and N,N-diethyl-N-methyl-N-(2-methoxyethyl)ammonium bis(trifluoromethanesulfonyl)amide (DEMETFSA) (Japanese Patent Application Publication No. 2011-003313 (JP 2011-003313 A)). As used herein, an “ionic liquid” refers to a substance composed solely of ionic molecules which are combinations of a cation and an anion, and denotes substances which are liquid at standard temperatures (15° C. to 25° C.).

### SUMMARY OF THE INVENTION

By using an ionic liquid such as PP13TFSA or DEMETFSA as an electrolyte solution for a lithium metal battery, a greater safety is achieved than before, but lithium metal batteries which use conventional ionic liquids such as PP13TFSA or DEMETFSA as an electrolyte solution still leave something to be desired in terms of battery power and capacity. Hence, there has existed a desire for an electrolyte solution which is capable of further enhancing the power and capacity of lithium metal batteries.

Extensive investigations have been carried out on electrolyte solutions that enhance the power and capacity of lithium metal batteries. As a result, it has been discovered that an ionic liquid having a cation that includes a nitrogen atom and an ether group, the nitrogen atom at the center of the cation and the oxygen atom on the ether group being arranged with a single carbon atom located between the nitrogen atom and the oxygen atom, has a lower lithium metal dissolution/precipitation resistance than conventional ionic liquids, and thus increases the power and capacity of lithium metal batteries.

Accordingly, this invention provides an electrolyte solution for a lithium metal battery, which electrolyte solution contains an ionic liquid having a cation that includes a nitrogen atom and an ether group. The nitrogen atom located at a center of the cation and the oxygen atom on the ether group are arranged with a single carbon atom being located between the nitrogen atom and the oxygen atom.

The electrolyte solution for a lithium metal battery provided by this invention has a low lithium metal dissolution/precipitation resistance.

### BRIEF DESCRIPTION OF THE DRAWINGS

Features, advantages, and the technical and industrial significance of exemplary embodiments of the invention will be described below with reference to the accompanying drawings, in which like numerals denote like elements, and wherein:

FIG. 1 is a graph showing the lithium dissolution/precipitation resistances of electrolyte solutions prepared in examples of the invention and comparative examples; and

FIG. 2 is a graph showing the lithium dissolution/precipitation resistances of electrolyte solutions prepared in examples of the invention.

### DETAILED DESCRIPTION OF EMBODIMENTS

Lithium metal batteries which use electrolyte solutions containing the hitherto used ionic liquid PP13TFSA or DEMETFSA leave something to be desired in terms of battery power and capacity.

In addressing this challenge, the inventors have found that by using in the electrolyte solution an ionic liquid containing a cation which includes a nitrogen atom and an ether group, wherein the nitrogen atom at a center of the cation and the oxygen atom on the ether group are arranged with a single carbon atom between the nitrogen atom and the oxygen atom, a lower lithium metal dissolution/precipitation resistance (lithium metal negative electrode resistance) is achieved than was possible before, enabling the power and capacity of the lithium metal battery to be improved. Here, “lithium metal battery” refers to a battery which uses lithium metal or a lithium alloy as the negative electrode.

The ionic liquid having a cation that includes a nitrogen atom and an ether group, the nitrogen atom at a center of the cation and the oxygen atom on the ether group being arranged with a single carbon atom located between the nitrogen atom and the oxygen atom, may include a quaternary ammonium cation of formula (1) below.

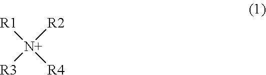

(In the above formula, at least one group from among R1, R2, R3 and R4 includes from 1 to 7 carbon atoms, a hydrogen atom and from 1 to 3 oxygen atoms. The nitrogen atom at the center of the cation and the oxygen atom which is present in at least one group containing an oxygen atom and is closest to the nitrogen atom are arranged with a single intervening carbon atom therebetween. Preferably, the nitrogen atom at the center of the cation and the oxygen atoms which are present in all the groups containing an oxygen atom and are closest to the nitrogen atom are arranged with a single intervening carbon atom therebetween. In addition, each of the remaining groups includes from 1 to 8 carbon atoms, a hydrogen atom and from 0 to 3 oxygen atoms, and the maximum total number of oxygen atoms included on R1, R2, R3 and R4 is 12.)

Alternatively, the ionic liquid having a cation which includes a nitrogen atom and an ether group, and in which the nitrogen atom located at a center of the cation and the oxygen atom on the ether group are arranged with a single intervening carbon atom therebetween may include a quaternary ammonium cation having the cyclic structure shown in formula (2) and an ether group. The quaternary ammonium cation shown in formula (2) may be used in combination with the quaternary ammonium cation shown in formula (1).

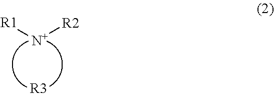

(In the above formula, at least one group from among R1 and R2 includes from 1 to 7 carbons, a hydrogen atom and from 1 to 3 oxygen atoms. The nitrogen atom at the center of the cation and the oxygen atom which is present in at least one group containing an oxygen atom and is closest to the nitrogen atom are arranged with a single intervening carbon atom therebetween. Preferably, the nitrogen atom at the center of the cation and the oxygen atoms which are present in all the groups containing an oxygen atom and are closest to the nitrogen atom are arranged with a single intervening carbon atom therebetween. In addition, the remaining group of R1 and R2 includes from 1 to 8 carbon atoms, a hydrogen atom and from 0 to 3 oxygen atoms, and the maximum total number of oxygen atoms included on R1 and R2 is 6. R3 includes from 2 to 7 carbon atoms and a hydrogen atom.)

The ionic liquid having a cation which includes a nitrogen atom and an ether group and in which the nitrogen atom located at a center of the cation and the oxygen atom on the ether group are arranged with a single intervening carbon atom therebetween is preferably an ionic liquid which includes the ammonium cation (N122.1o1) of formula (3) below

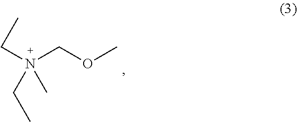

the N-methyl-N-methoxymethyl pyrrolidinium (P1.1o1) of formula (4) below

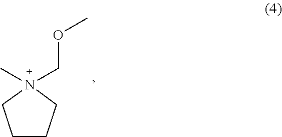

or a mixture thereof.

By using as the electrolyte solution an ionic liquid which includes a cation wherein an ether group has been incorporated in such a way that the oxygen atom in the ether group and the nitrogen atom at the center of the cation are arranged with a single intervening carbon atom therebetween, the lithium metal dissolution/precipitation resistance (lithium metal negative electrode resistance) can be made lower than before. Lowering the lithium metal negative electrode resistance enables the power and capacity of the lithium metal battery to be increased.

Without getting too theoretical, because ether groups are electron-donating and readily interact with lithium ions, in a cation wherein an ether group has been incorporated in such a way that the oxygen atom on the ether group and the nitrogen atom at the center of the cation are arranged with a single intervening carbon atom therebetween, the charge density at the center of the cation is lower and the cation is readily adsorbed to the electrode. Hence, the cation layer adsorbed to the electrode surface tends to become thin, and the interfacial resistance appears to decrease. Moreover, because the straight-chained cation of formula (1) or (3) has a skeleton that is flexible (bends easily) compared with cyclic cations like those of formula (2) or (4), the adsorbed cation layer tends to become thinner, apparently further decreasing the interfacial resistance.

By way of illustration, formulas (5) to (7) below show the P14, PP13 and DEME, which have the cation structures used in the comparative examples:

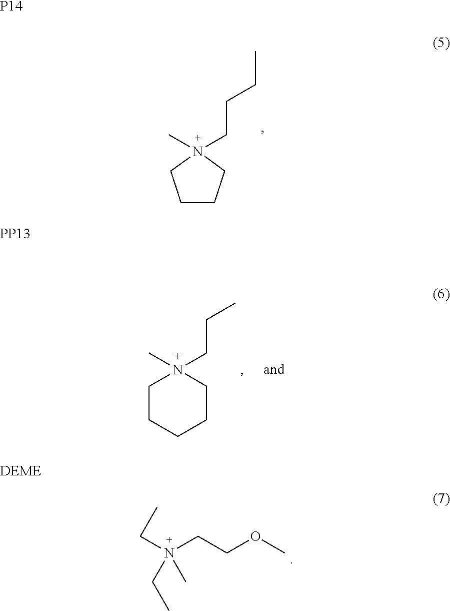

Compared with electrolyte solutions containing ionic liquids having the cations of formulas (5) to (7) shown above as the comparative examples, the electrolyte solution of this invention can further lower the lithium metal dissolution/precipitation resistance than before.

The electrolyte solution of this invention may include an anion portion. Illustrative examples of the anion portion include the bis(trifluoromethanesulfonyl)amide (TFSA) of formula (8) below, tetrafluoroborate, hexafluorophosphate and triflate. The use of TFSA is preferred. More preferably, the electrolyte solution of this invention includes N-methyl-N-methoxymethyl-pyrrolidinium bis(trifluoromethanesulfonyl)amide (P1.1o1TFSA), N,N-diethyl-N-methyl-N-methoxymethylammonium (N122.1o1TFSA), or a mixture thereof.

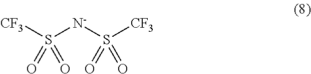 [SMILES: O=S(=O)([N-]S(=O)(=O)C(F)(F)F)C(F)(F)F]

The electrolyte solution of the invention may include a lithium-containing metal salt. Lithium-containing metal salts that may be used include salts composed of a lithium ion and any of the following anions: halide anions such as cl⁻, Br⁻, and I⁻, boride anions such as BF₄⁻, B(CN)₄⁻ and B(C₂O₄)₂⁻; amide anions or imide anions such as (CN)₂N⁻, [N(CF₃)₂]⁻ and [N(SO₂CF₃)₂]⁻; sulfate anions or sulfonate anions such as RSO₃⁻ (here and below, R being an aliphatic hydrocarbon group or an aromatic hydrocarbon group), RSO₄⁻, R^{f}SO₃⁻ (here and below, R^{f} being a fluorine-containing halogenated hydrocarbon group) and R^{f}SO₄⁻; phosphorus-containing anions such as R^{f}₂P(O)O⁻, PF₆⁻ and R^{f}₃PF₃⁻; antimony-containing anions such as SbF₆; and lactate, nitrate ion, trifluoroacetate and tris(trifluoromethanesulfonyl)methide. Illustrative examples of such salts include LiPF₆, LiBF₄, lithium bis(trifluoromethanesulfonyl)amide (LiN(CF₃SO₂)₂; referred to below as “LiTFSA”), LiCF₃SO₃, LiC₄F₉SO₃, LiC(CF₃SO₂)₃ and LiClO₄. The use of LiTFSA is preferred. Two or more such lithium-containing metal salts may be used in combination. The amount of lithium-containing metal salt with respect to the ionic liquid, although not particularly limited, is preferably set to from about 0.1 mol/kg to about 1 mol/kg.

A lithium metal battery can be manufactured using the electrolyte solution of the invention. The lithium metal battery can have a positive electrode layer, a negative electrode layer and an electrolyte layer disposed between the positive electrode layer and the negative electrode layer, which electrolyte layer may include the electrolyte solution according to the invention.

The electrolyte solution of the invention is capable of exchanging lithium ions between the positive electrode layer and the negative electrode layer.

An ionic liquid having a cation which includes a nitrogen atom and an ether group, and in which the nitrogen atom located at a center of the cation and the oxygen atom on the ether group are arranged with a single intervening carbon atom therebetween, may itself be used as the electrolyte. Alternatively, the electrolyte used may be an ionic liquid added with another ionic liquid such as P14TFSA, PP13TFSA or DEMETFSA, and/or an organic solvent such as propylene carbonate, ethylene carbonate, diethyl carbonate, dimethyl carbonate, ethyl methyl carbonate, 1,2-dimethoxyethane, 1,2-diethoxyethane, acetonitrile, propionitrile, tetrahydrofuran, 2-methyltetrahydrofuran, dioxane, 1,3-dioxolane, nitromethane, N,N-dimethylformamide, dimethylsulfoxide, sulfolane, γ-butyrolactone or a glyme.

The ionic liquid-containing electrolyte solution of the invention may also include an organic solvent. By using an organic solvent having a lower viscosity than the ionic liquid in combination with the ionic liquid as the electrolyte solution, the viscosity of the electrolyte solution can be lowered, the low-viscosity electrolyte solution is able to rapidly supply lithium ions to the electrodes, and the capacity and power of the lithium metal battery can be enhanced.

The organic solvent which may be included in the ionic liquid-containing electrolyte solution of the invention is exemplified by solvents which have a lower viscosity than the ionic liquid, are compatible with the ionic liquid, and do not contain active protons. The organic solvent is preferably an organic solvent having an ether group, and more preferably a glyme. Illustrative examples of suitable glymes include tetraglyme and triglyme. A glyme may be advantageously used in admixture with P1.1o1TFSA, N122.1o1TFSA, or a mixture thereof.

The proportion (mol %) of organic solvent with respect to the overall amount of the electrolyte solution solvent containing the ionic liquid and the organic solvent is preferably not more than 98%, more preferably not more than 95%, even more preferably not more than 93.3%, still more preferably not more than 68%, and most preferably not more than 50%.

It is also possible to use, as the electrolyte, the ionic liquid-containing electrolyte solution of the invention together with, for example, a polymer electrolyte or a gel electrolyte.

The polymer electrolyte which may be used together with the ionic liquid-containing electrolyte solution of the invention preferably includes a lithium salt and a polymer. The lithium salt is not particularly limited, provided it is a lithium salt that has hitherto been commonly used in lithium metal batteries and the like. Examples include lithium salts that may be used as the above-mentioned lithium-containing metal salts. The polymer is not particularly limited, provided it forms a complex with the lithium salt, and is exemplified by polyethylene oxide.

The gel electrolyte which can be used together with the ionic liquid-containing electrolyte solution of the invention is preferably one which includes a lithium salt, a polymer and a nonaqueous solvent. The above-mentioned lithium salts may be used as the lithium salt. The nonaqueous solvent is not particularly limited, provided it is one capable of dissolving the lithium salt. For example, the above-mentioned organic solvents may be used for this purpose. These nonaqueous solvents may be used singly, or two or more may be used in admixture. The polymer is not particularly limited, provided it is one capable of gelation. Illustrative examples include polyethylene oxide, polypropylene oxide, polyacrylonitrile, polyvinylidene fluoride (PVDF), polyurethane, polyacrylate and cellulose.

The positive electrode layer included in the lithium metal battery manufactured using the electrolyte solution of the invention may contain a material capable of being used as a positive electrode active material in lithium metal batteries. Illustrative examples of positive electrode active materials include transition metal oxides such as lithium cobaltate (LiCoO₂), lithium nickelate (LiNiO₂), lithium manganate (LiMn₂O₄), Li—Mn spinels which are substituted with other elements and are of the composition LiCo_{1/3}Ni_{1/3}Mn_{1/3}O₂ or Li₁₊ₓMn_{2-x-y}M_{y}O₄ (wherein M is one or more metal element selected from among aluminum, magnesium, cobalt, iron, nickel and zinc), lithium titanate (LiₓTiO_{y}), metal-lithium phosphate (LiMPO₄, wherein M is iron, manganese, cobalt or nickel), vanadium oxide (V₂O₅) and molybdenum oxide (MoO₃); titanium sulfide (TiS₂); carbon materials such as graphite and hard carbon; lithium cobalt nitride (LiCoN), lithium silicon oxide (LiₓSi_{y}O_{z}), lithium-intercalating intermetallic compounds (MgₓM or N_{y}Sb, wherein M is tin, germanium or antimony and N is indium, copper or manganese), and derivatives thereof.

The positive electrode layer may include a binder. Desirable examples of the binder material include, but are not particularly limited to, polytetrafluoroethylene, polytrifluoroethylene, polyethylene, nitrile rubber, polybutadiene rubber, butyl rubber, hydrogenated butylene rubber, polystyrene, styrene-butadiene rubber, styrene-butadiene latex, polysulfonated rubber, nitrocellulose, acrylonitrile-butadiene rubber, polyfluorinated vinyl, polyfluorinated vinylidene and fluororubber.

The positive electrode layer may optionally include conductive additive particles. The conductive additive particles are not particularly limited; use may be made of, for example, graphite or carbon black.

Lithium metal or a lithium alloy, either alone or in admixture, may be used as the negative electrode active material. Examples of substances capable of forming alloys with lithium metal include aluminum, magnesium, potassium, sodium, calcium, strontium, barium, silicon, germanium, antimony, lead, tin, indium and zinc.

The lithium metal battery of the invention may also include a separator to prevent shorting between the positive electrode and the negative electrode. The separator is not particularly limited; materials hitherto used in lithium metal batteries may be employed for this purpose. For example, use may be made of polymer-based nonwoven fabrics such as polypropylene nonwoven fabrics or polyphenylene sulfide nonwoven fabrics; porous films made of an olefin resin such as polyethylene or polypropylene; or combinations of the above. It is also possible to form an electrolyte layer by impregnating an electrolyte such as a liquid electrolyte into a separator.

A positive electrode current collector may be disposed adjacent to the positive electrode layer. The positive electrode current collector material is not particularly limited, provided it has electrical conductivity and functions as a positive electrode current collector. Illustrative examples include stainless steel, aluminum, copper, nickel, iron, titanium and carbon. Stainless steel and aluminum are preferred. The positive electrode current collector may be in the form of, for example, a foil, sheet or mesh.

A negative electrode current collector may be disposed adjacent to the negative electrode layer. The negative electrode current collector material is not particularly limited, provided it has electrical conductivity and functions as a negative electrode current collector. Illustrative examples include stainless steel, copper, nickel and carbon. Stainless steel and copper are preferred. The negative electrode current collector may be in the form of for example, a foil, sheet or mesh.

The battery case used to enclosed the lithium metal battery may be a conventional laminate film which is capable of being used in lithium metal batteries.

The lithium metal battery may assume a desired shape, such as a cylindrical, prismatic, button-like, coin-like or flattened shape, but is not limited to these.

The lithium metal battery may be a lithium air battery, which lithium air battery may have a conventional construction. For example, in the above-described lithium metal battery, the positive electrode layer and the positive electrode current collector can be manufactured with a construction that takes up an oxygen-containing gas such as air and can utilize oxygen as the active material.

The positive electrode (air electrode) of a lithium air battery may include a conductive material. Preferred conductive materials include, but are not limited to, porous materials. Examples of porous materials include carbon materials such as carbon. The carbon may be, for example, a carbon black such as ketjen black, acetylene black, channel black, furnace black or mesoporous carbon; activated carbon, or carbon fibers. The use of a carbon material having a large specific surface area is preferred. It is desirable for the porous material to have a pore volume of about 1 mL/g in the order of nanometer. The conductive material accounts for preferably from 10 to 99 wt % of the positive electrode (air electrode) layer.

The positive electrode (air electrode) layer may include a binder similar to that of the positive electrode layer in the above-described lithium metal battery. The binder accounts for preferably from 1 to 40 wt % of the positive electrode (air electrode) layer.

The positive electrode (air electrode) layer may include a redox catalyst. Illustrative examples of redox catalysts include metal oxides such as manganese dioxide, cobalt oxide and cerium oxide; noble metals such as platinum, palladium, gold and silver; transition metals such as cobalt; and organic materials such as metal phthalocyanines (e.g., cobalt phthalocyanine) and iron porphyrin. The redox catalyst accounts for preferably from 1 to 90 wt % of the positive electrode (air electrode) layer.

The positive electrode (air electrode) current collector in a lithium air battery likewise can be disposed adjacent to the positive electrode (air electrode) layer. The material used as the positive electrode (air electrode) current collector in a lithium air battery is not particularly limited, provided it is a material that has hitherto been used as a current collector, including carbon paper, porous or mesh-like structures (e.g., metal mesh), fibers, and nonwoven fabric. For example, use can be made of metal mesh formed of stainless steel, nickel, aluminum, iron or titanium. A metal foil having oxygen supply holes may be used as the positive electrode (air electrode) current collector.

The negative electrode layer, negative electrode current collector and separator included in a lithium air battery built using the electrolyte solution of the invention may be made of materials similar to those used in the above-described lithium metal battery.

Housing materials that can be used in lithium air batteries constructed using the electrolyte solution of the invention may be materials similar to those used in lithium metal batteries, provided the positive electrode (air electrode) layer has holes for the supply of oxygen.

A lithium air battery constructed using the electrolyte solution of the invention may include an oxygen permeable membrane. The oxygen permeable membrane may be disposed, for example, over the positive electrode (air electrode) layer and on the side opposite from that of the electrolyte layer; that is, on the side which comes into contact with air. A water-repelling porous membrane which allows the oxygen within air to pass through and can prevent the entry of moisture may be used as the oxygen permeable membrane. For example, use may be made of a porous membrane composed of polyester or polyphenylene sulfide. It is also possible for a water-repelling film to be separately provided.

The shape of the lithium air battery constructed using the electrolyte solution of the invention is not particularly limited, provided it is a shape having oxygen uptake holes. The shape may be similar to that in lithium metal batteries.

Lithium metal batteries and lithium air batteries constructed using the electrolyte solution of the invention may be used as primary batteries or secondary batteries.

Batteries constructed using the electrolyte solution of the invention can be formed by any method hitherto used in the art. A method of forming the positive electrode (air electrode) layer included in a lithium air battery constructed using the electrolyte solution of the invention is described by way of illustration. For example, a positive electrode (air electrode) layer containing carbon particles and a binder can be formed by adding a suitable amount of a solvent such as ethanol to given amounts of carbon particles and binder, mixing the ingredients, then rolling the resulting mixture with a roll press to a given thickness, drying and cutting. Next, by pressure-bonding the positive electrode current collector and drying under applied heat and a vacuum, a positive electrode (air electrode) layer having a current collector combined therewith can be obtained.

Another method for obtaining a positive electrode (air electrode) layer entails adding a suitable amount of a solvent to given amounts of carbon particles and binder, mixing the ingredients to form a slurry, then coating the slurry onto a substrate and drying. If desired, the positive electrode (air electrode) layer obtained may be press-molded. A solvent which has a boiling point of 200° C. or less, such as acetone or NMP, may be used as the solvent for obtaining the slurry. The process used to coat the slurry onto the positive electrode (air electrode) layer substrate may be, for example, a doctor blade method, gravure transfer or inkjet printing. The substrate used here is not particularly limited, the use of current collecting plates utilized as current collectors, substrates having a film-like flexibility, or rigid substrates being possible. For example, use may be made of a substrate such as stainless steel foil, polyethylene terephthalate (PET) film or Teflon®.

(Solvent Preparation)

The solvent used in the electrolyte solution was prepared. In the case of

N-methyl-N-methoxymethyl-pyrrolidinium bis(trifluoromethanesulfonyl)amide (P1.101TFSA), synthesis was carried out with N-methylpyrrolidine and bromomethyl methyl ether and using a method similar to that for the conventional substance DEMETFSA. In the case of N,N-diethyl-N-methyl-N-methoxymethylammonium (N122.1o1TFSA), synthesis was carried out with N,N-diethylmethylamine and bromomethyl methyl ether and using a method similar to that for the conventional substance DEMETFSA. As for P14 bis(trifluoromethanesulfonyl)amide (P14TFSA), PP13TFSA and DEMETFSA, these were procured from Kanto Kagaku Co., Ltd.

### EXAMPLE 1

An electrolyte solution was prepared by using P1.1o1TFSA as the solvent, weighing out and mixing LiTFSA (produced by Kishida Chemical Co., Ltd.) to a concentration of 0.35 mol/kg in a 60° C. argon atmosphere, and stirring for 6 hours.

### EXAMPLE 2

An electrolyte solution was prepared by using N122.1o1TFSA as the solvent, weighing out and mixing LiTFSA (produced by Kishida Chemical Co., Ltd.) to a concentration of 0.35 mol/kg in a 60° C. argon atmosphere, and stirring for 6 hours.

### COMPARATIVE EXAMPLE 1

An electrolyte solution was prepared by using P14TFSA as the solvent, weighing out and mixing LiTFSA (produced by Kishida Chemical Co., Ltd.) to a concentration of 0.35 mol/kg in a 60° C. argon atmosphere, and stirring for 6 hours.

### COMPARATIVE EXAMPLE 2

An electrolyte solution was prepared by using PP13TFSA as the solvent, weighing out and mixing LiTFSA (produced by Kishida Chemical Co., Ltd.) to a concentration of 0.35 mol/kg in a 60° C. argon atmosphere, and stirring for 6 hours.

### COMPARATIVE EXAMPLE 3

An electrolyte solution was prepared by using DEMETFSA as the solvent, weighing out and mixing LiTFSA (produced by Kishida Chemical Co., Ltd.) to a concentration of 0.35 mol/kg in a 60° C. argon atmosphere, and stirring for 6 hours.

(Evaluation of Lithium Metal Dissolution/Precipitation Resistance)

Electrochemical measurement was carried out under the following conditions on the electrolyte solutions prepared in Examples 1 and 2 and Comparative Examples 1 to 3, and the lithium metal dissolution/precipitation resistance in each case was evaluated.

Three-electrode measurement cells equipped with Ni (dia., 1.5 mm) as the working electrode, Ag/Ag⁺ as the reference electrode, and Pt as the counterelectrode, and a potentiostat/galvanostat (Solartron) as the measurement device were furnished for use. The atmosphere within the measurement cells was replaced with argon atmosphere, following which the measurement cells filled with the respective electrolyte solutions were left to stand for 3 hours in a thermostatic chamber at 25° C. and 1 atmosphere. Cyclic voltammetry (CV) was then carried out under specific conditions (25° C., in argon, 1 atmosphere) by scanning ±0.1 V versus Ag/Ag⁺ before and after lithium precipitation at a scan rate of 10 mV/s. Next, based on the results of cyclic voltammetry (CV), the voltage-current slope at the time of lithium dissolution/precipitation was calculated as the lithium dissolution/precipitation resistance.

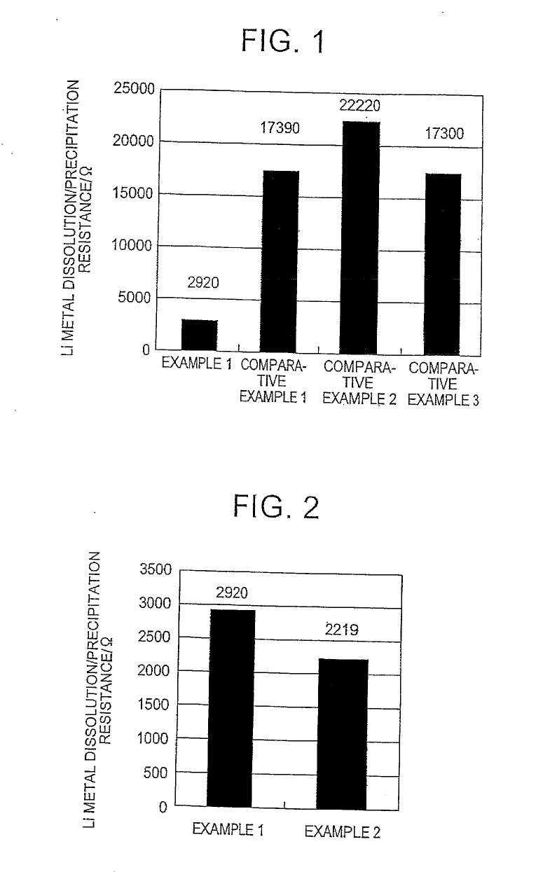

The lithium dissolution/precipitation resistances measured for the respective electrolyte solutions are shown in FIGS. 1 and 2 and in Table 1. As shown in FIG. 1, the resistance of the electrolyte solution prepared in Example 1 decreased to about ⅙ the resistances for the electrolyte solutions prepared in Comparative Examples 1 to 3. As shown in FIG. 2, the resistance of the electrolyte solution prepared in Example 2 further decreased to about ¾ the resistance for the electrolyte solution prepared in Example 1.

TABLE 1

| | | Li metal dissolution/ |
|---|---|---|
| | Electrolyte | precipitation resistance |
| | solution | (Ω) |
| Example 1 | P1.1o1TFSA | 2,920 |
| Example 2 | N122.1o1TFSA | 2,219 |
| Comparative Example 1 | P14TFSA | 17,390 |
| Comparative Example 2 | PP13TFSA | 22,220 |
| Comparative Example 3 | DEMETFSA | 17,300 |

1. An electrolyte solution for a lithium metal battery, containing an ionic liquid that has a cation that includes a nitrogen atom and an ether group, the nitrogen atom at a center of the cation and the oxygen atom on the ether group being arranged with a single carbon atom located between the nitrogen atom and the oxygen atom.

2. The electrolyte solution according to claim 1, wherein the cation is straight-chained.

3. The electrolyte solution according to claim 1, wherein the ionic liquid includes the ammonium cation (N122.1o1) represented by formula (3) below: 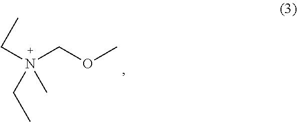
the ammonium cation (P1.101) represented by formula (4) below: 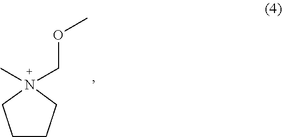
or a mixture thereof.

4. The electrolyte solution according to claim 1, further comprising an organic solvent.

5. The electrolyte solution according to claim 1, further comprising bis(trifluoromethanesulfonyl)amide (TFSA) represented by formula:

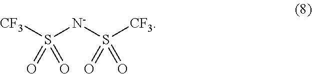 [SMILES: O=S(=O)([N-]S(=O)(=O)C(F)(F)F)C(F)(F)F]

6. The electrolyte solution according to claim 1, further comprising a lithium-containing metal salt.

7. The electrolyte solution according to claim 6, wherein the lithium-containing metal salt is lithium bis(trifluoromethanesulfonyl)amide (LiTFSA).

8. A lithium metal battery comprising:
a positive electrode layer,
a negative electrode layer, and
an electrolyte layer which includes the electrolyte solution of claim 1 and is disposed between the positive electrode layer and the negative electrode layer.
